(19) United States
(12) Patent Application Publication
(10) Pub. No.: US 2007/0097974 A1
(43) Pub. Date: May 3, 2007

(54) Distributed border gateway protocol (BGP) route reflector system

(76) Inventors: David D. Ward, Somerset, WI (US); John Scudder, Ann Arbor, MI (US); Stefano Previdi, Rome (IT); Clarence Filsfils, Brussels (BE); Robert Raszuk, Komorow (PL)

Correspondence Address: HICKMAN PALERMO TRUONG & BECKER, LLP, 2055 GATEWAY PLACE, SUITE 550, SAN JOSE, CA, 95110, US

(21) Appl. No.: 11/262,061

(22) Filed: Oct. 28, 2005

(51) Int. Cl. H04L 12/56; H04J 3/22; H04L 12/28; H04J 3/16

(52) U.S. Cl. 370/392; 370/465

(57) ABSTRACT

A packet data router comprises one or more first circuit boards comprising one or more first processors and first logic circuits programmed to perform packet data forwarding and packet data router control plane functions; and one or more second circuit boards comprising one or more second processors and second logic circuits programmed to perform only Border Gateway Protocol (BGP) route reflection server (RRS) functions. A distributed BGP route reflector system with the disclosed architecture distributes route reflection server software to a dedicated control board so that processing route reflection functions does not impact packet forwarding or protocol instances that converge forwarding tables.

### CROSS-REFERENCE TO RELATED APPLICATION

This application is related to prior co-pending application Ser. No. 10/677,797, filed Oct. 2, 2003, the entire contents of which are hereby incorporated by reference for all purposes as if fully set forth herein.

### FIELD OF THE INVENTION

The present invention generally relates to communicating network routing information using Border Gateway Protocol (BGP). The invention relates more specifically to architectural structures for implementing BGP hosts.

### BACKGROUND

The approaches described in this section could be pursued, but are not necessarily approaches that have been previously conceived or pursued. Therefore, unless otherwise indicated herein, the approaches described in this section are not prior art to the claims in this application and are not admitted to be prior art by inclusion in this section.

Border Gateway Protocol (BGP) is a path vector routing protocol for exchanging routing information among network elements in the same or different Autonomous System (AS). The function of a BGP-enabled network element (a BGP host or peer) is to exchange network reachability information with other BGP-enabled network elements. The most commonly implemented version of BGP is BGP-4, which is defined in RFC1771 (published by the Internet Engineering Task Force (IETF) in March 1995).

To exchange routing information, two BGP hosts first establish a BGP peering session by exchanging BGP OPEN messages. The BGP hosts then exchange their full routing tables. After this initial exchange, each BGP host sends to its BGP peer or peers only incremental updates for new, modified, and unavailable or withdrawn routes in one or more BGP UPDATE messages. A route is a unit of information that pairs a network destination with the attributes of a network path to that destination. Examples of path attributes include, but are not limited to, the ORIGIN attribute (which indicates how a BGP peer learned about a route), the AS_PATH attribute (which indicates the Autonomous Systems through which a route passes), the NEXT_HOP attribute (which is the address of the border router that is the next hop in a route), and the LOCAL_PREF attribute (which indicates the BGP peer's degree of preference of an exit point from the local AS for a route).

Significantly increasing the number of network nodes that can receive BGP services is a serious problem encountered in deploying and managing service provider networks. Several constraints in the operation of BGP impose limits on scalability. A first problem affecting service provider BGP scalability is the large number of services that BGP can carry. BGP can transport routes organized in different address families or sub-address families (“services” over BGP), such as IPv4, IPv6, VPNv4, multicast VPNs, VPLS, etc.

Further, BGP is structured to expect that all BGP peers are connected in a fully-meshed network configuration. This requirement means that n BGP peers require a total of n² connections. Route reflection is a technique that some service providers use to avoid the requirement of full meshing. The use of BGP route reflection server (RRS) devices relieves the requirement of actually fully meshing BGP peers, because the BGP RRS effectively acts as a centralization point of a number of clients to a server that chooses the best path between them and reflect the best path to other nodes. The BGP RRS also can compute a best path based on all paths that the RRS receives from internal BGP peers, and reflect the best path back to clients. The use of route reflection can reduce the total number of required connections to as little as n log n.

Typically, a service provider configures an existing router in the service provider network as a BGP route reflector (RR) or RRS; the router performs RR services in addition to core routing and packet forwarding. This approach is undesirable because performing RR services negatively impacts routing table convergence time, as the reflecting router may not be in the forwarding path of reflected routes. Further, a conventional router may not be powerful enough to perform packet forwarding, control plane processing, and all BGP route reflection services concurrently.

Alternatively, a packet data router is configured as a route reflector, but packet forwarding functions and control plane functions are disabled on the router. For example, a Cisco 7200 router or a low-end server computer can be configured as an external device that performs nothing but route reflection services. However, introducing a new network node just to perform route reflection services is undesirable because of the direct costs involved, and because a new node is introduced into the IGP network increases network complexity and management burden.

Thus, there is a need to somehow add route reflection capability to a router with sufficient processing capacity to perform route reflection in addition to packet forwarding and routing, without adversely affecting convergence.

Free routing application software including BGP functions is commercially available in open source software form from Zebra, at www.zebra.org, and Quagga, at www.quagga.net, but these offerings do not address all of the shortcomings outlined above.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram that illustrates an overview of an example operational context in which BGP route reflector services may be implemented in conventional practice;

FIG. 2 is a block diagram of a packet router having a distributed architecture according to the approaches herein;

FIG. 3 is a block diagram of a packet router of FIG. 2 illustrating an example route information base (RIB) architecture.

### DETAILED DESCRIPTION

A packet data router having a distributed design to scale Border Gateway Protocol (BGP) route reflector services is described. In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

Embodiments are described herein according to the following outline:
1.0 General Overview
2.0 Structural and Functional Overview
3.0 Distributed Design to Scale BGP Route Reflector Server
4.0 Implementation Mechanisms-Hardware Overview
5.0 Extensions and Alternatives
   1.0 General Overview

The needs identified in the foregoing Background, and other needs and objects that will become apparent for the following description, are achieved in the present invention, which comprises, in one aspect, a packet data router, comprising one or more first circuit boards comprising one or more first processors and first logic circuits programmed to perform packet data forwarding and packet data router control plane functions; one or more second circuit boards comprising one or more second processors and second logic circuits programmed to perform only Border Gateway Protocol (BGP) route reflection server (RRS) functions.

In one feature of this aspect, the BGP RRS functions comprise a BGP peer state machine function, a BGP route information base (RIB) function, and a host I/O stack function. In another feature, the BGP RRS functions exclude a BGP global RIB function. In still another feature, the BGP RRS functions comprise communicating using an inter-processor communication service to contact a separate global RIB to perform next hop resolution.

According to yet another feature, the router comprises a plurality of the second circuit boards, wherein each of the second circuit boards hosts an instance of BGP RRS functions. In still another feature, each independent instance processes BGP information only for a particular address family and for all sub-address families that are associated with the particular address family. In another feature, each independent instance processes BGP information only for a particular service among a plurality of services that use BGP, and for all AFIs and SAFIs that use the particular service.

In still another feature, the first circuit boards each comprise a switching system, forwarding plane logic, and control plane logic, and wherein the second circuit boards do not comprise a switching system, forwarding plane logic, or control plane logic.

According to another aspect, the invention provides a packet data routing apparatus, comprising first circuit means comprising one or more first processors and first logic circuits for performing packet data forwarding and packet data router control plane functions; and second circuit means comprising one or more second processors and second logic circuits for performing only Border Gateway Protocol (BGP) route reflection services (RRS).

In other aspects, the invention encompasses a method of manufacturing the foregoing apparatus and a method of using the foregoing apparatus.

2.0 Structural and Functional Overview

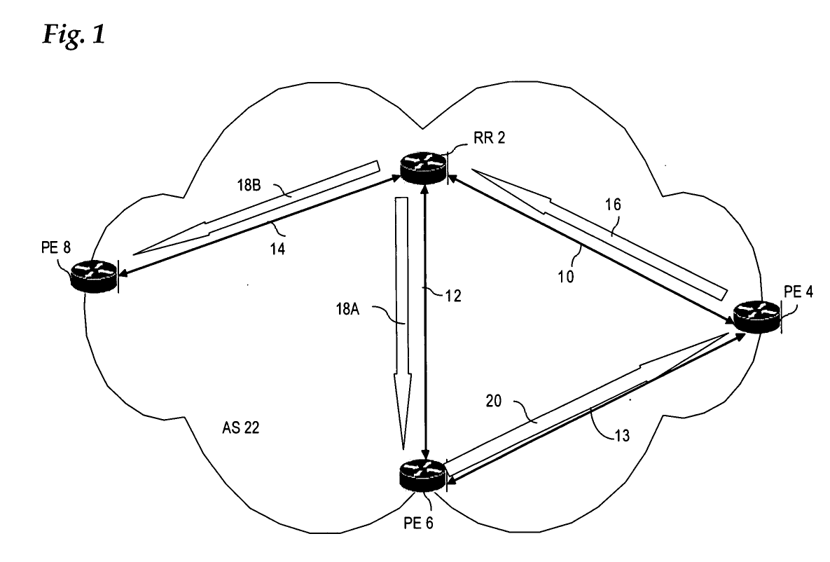

FIG. 1 is a block diagram that illustrates an overview of an example operational context in which BGP route reflector services may be implemented in conventional practice, provided to illustrate deficiencies of such prior approaches and contrasts with the present approach.

Autonomous System (AS) 22 includes Provider Edge (PE) routers 4, 6, and 8. Each of PE 4, 6, and 8 is a BGP host that executes one or more BGP processes and performs the functions of an Autonomous System Border Router (ASBR) that exchanges routing information with ASBRs in other autonomous systems. As depicted in FIG. 1, PE 4, 6, and 8 are established on the edges of AS 22. The techniques described herein, however, are not limited to being implemented only in the context of provider edge routers. For example, any network element that executes a BGP process can implement the techniques described herein regardless of whether that network element is established within the network or on the edge of the network. Thus, the operational context depicted in FIG. 1 is to be regarded in an illustrative rather than a restrictive sense.

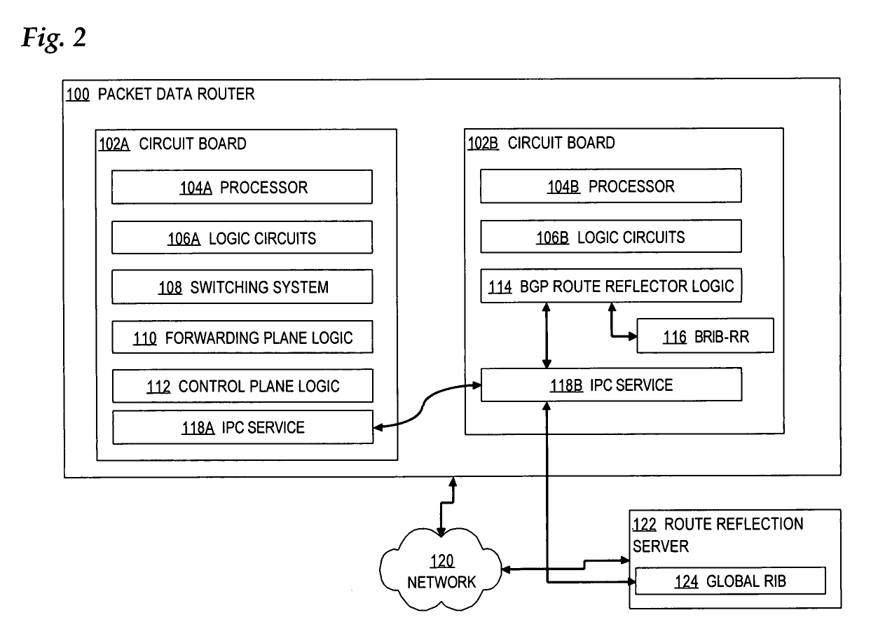

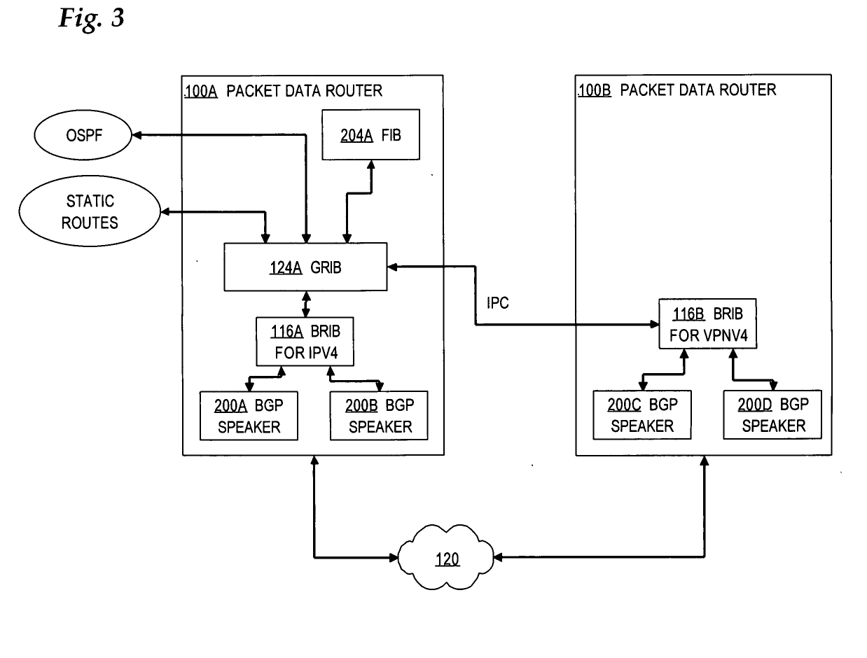

AS 22 also includes a Route Reflector (RR) 2, which re-advertises, or reflects, routes to PE 4, 6, and 8. In conventional practice, RR 2 may comprise a dedicated server computer, or a packet router in which route computation and packet forwarding functions are disabled. With the approaches herein, RR 2 uses a distributed architecture of FIG. 2, FIG. 3 and can perform all of packet forwarding, route computation and route reflector services.

RR 2 and PE routers 4, 6, and 8 establish BGP peering sessions among themselves as illustrated by links 10, 12, 13, 14 that may carry BGP OPEN and UPDATE messages as illustrated by flows 16, 18A, 18B, 20.

In one embodiment, RR 2 operates according to the Route Reflection mechanism described in RFC2796, which was published by IETF in April 2000. According to RFC2796, a route reflector is BGP host that advertises to another BGP host routes learned through BGP. A route reflector may establish BGP sessions with one or more BGP peers, where each BGP session is configured for exchanging routes of one particular type, such as, for example, IPv4 unicast or IPv6 unicast routes. A route reflector may use the same BGP session with the same BGP peer for exchanging routes of different route types.

There are two types of BGP peers that may be associated with a route reflector: client peers, and non-client peers. A non-client BGP peer of the route reflector must be fully meshed, but a client BGP peer of the route reflector need not be fully meshed with the other client BGP peers of the route reflector. A route reflector along with its client BGP peers form a route reflection cluster. The route reflector may reflect routes among client BGP peers, among non-client BGP peers, or between client and non-client BGP peers. For example, when a route reflector learns a route from any of its BGP peers, it reflects the route in the following manner: if the route is learned from a non-client BGP peer then the route is reflected to all of the route reflector's client BGP peers; in one approach, if the route is learned from a client BGP peer then the route is reflected to all of the route reflector's non-client BGP peers as well as to all of the route reflector's client BGP peers other than the client BGP peer from which the route was learned, although such a “split horizon” approach is not strictly required. A peer receiving back a route in which the next hop is that peer may silently drop that route.

According to one embodiment of the invention, a packet data router comprises one or more first circuit boards and one or more second circuit boards. The first circuit boards comprise first processors and logic programmed to perform packet data forwarding and packet data router functions. The second circuit boards comprise second processors and logic programmed to perform border gateway protocol (BGP) route reflection server (RRS) functions.

In an embodiment, the route reflection server functions comprise a subset of functions, the execution of which by the second processors does not affect packet forwarding, protocol instances that converge forwarding tables, or other functions of the first processors.

For example, in one embodiment, the second processors and logic host or implement only such functions as are necessary for the second processors and logic to provide a BGP route reflection service. Such functions may exclude some BGP-related functions that may be found in a standalone implementation of BGP route reflection services.

In one embodiment, the second processors and second logic host software elements that implement a BGP peer state machine, a BGP route information base (RIB) configured to perform intra-protocol route comparison operations, and a host I/O stack.

In an embodiment, the second processors and second logic do not host, for example, a global RIB configured to perform inter-protocol comparison. Instead, the second processors and second logic use an inter-processor communication (IPC) service to contact the global RIB at another processor or server when necessary, typically only for resolution of next hops. No route download or route redistribution to the second processors or second logic occurs. Therefore, IPC traffic is minimized.

Further, in an embodiment, no delay in route advertisements, to wait for routes to download to a RIB, is needed as on a conventional router. Route reflection servers do not install routes into a RIB; therefore, operation of the second processors and second logic as disclosed herein cannot affect packet-forwarding functions of the first processors and first logic.

In another embodiment, the second processors and second logic perform BGP route reflection services only for a particular address family of prefixes. A plurality of other sets of processors and logic perform route reflection services for other address families. This approach achieves even greater scalability by distributing BGP route reflection servers across different address families.

In yet another embodiment, the second processors and second logic perform BGP route reflection services only for a particular route service that uses BGP, but for all prefixes that use the service. Examples of services that may have a dedicated route reflection server, implemented using a particular second processor and second logic, include Layer 3 VPN services, VPLS, and any other service that uses BGP and does not affect packet forwarding.

3.0 Distributed Design to Scale BGP Route Reflector Server

FIG. 2 is a block diagram of a packet router having a distributed architecture according to the approaches herein. A packet data router 100 comprises at least one first circuit board 102A and at least one second circuit board 102B. In one embodiment, the packet data router 100 may have a plurality of first circuit boards 102A and a corresponding plurality of second circuit boards 102B. For example, the architecture of FIG. 2 may be made fault-tolerant by using two redundant circuit boards for each of the circuit boards 102A, 102B.

Circuit board 102A comprises at least one processor 104A, one or more logic circuits 106A, a switching system 108, forwarding plane logic 110, and control plane logic 112. The foregoing components of circuit board 102A cooperate to provide packet receiving, buffering, and filtering, to perform routing decisions, and to perform packet forwarding in the manner of a conventional router in a packet-switched network. Control plane logic 112 is responsible for route advertisement and route selection functions. Forwarding plane logic 110 is responsible for route forwarding functions.

Circuit board 102A may also host one or more software elements that provide core network element fictions such as network access, SNMP, database interaction, operating system interaction, ICMP, and operation of passive IGPs such as OSPF and ISIS. Embodiments may host a Web-based management console that communicates over HTTPS to a Web browser.

Circuit board 102B comprises at least one processor 104B, logic circuits 106B, BGP route reflector logic 114, and an IPC service 118. A local BGP route information base (BRIB) 116 for route reflection services is coupled to route reflector logic 114. Processor 104B and logic circuits 106B provide supervisory control of circuit board 102B and interfacing with circuit board 102A using IPC service 118. BGP route reflector logic 114 includes peer state machine logic, logic for managing BRIB 116 to make intra-protocol comparisons, and a host I/O stack implementation.

Circuit board 102B communicates with circuit board 102A and with other BGP peers using RPC service 118. Further, circuit board 102B is logically coupled using IPC service 118 through a network 120 to a peer route reflection server 122 that holds a global RIB 124. Global RIB 124 provides a database of prefixes that are used for inter-protocol comparison.

Thus, FIG. 2 indicates that the global RIB does not need to be located on the same device as circuit board 102B. Further, with the architecture of FIG. 2, interaction of the second circuit board 102B over IPC 118 with the global RIB 124 is minimized. BRIB 116 contacts global RIB (GRIB) 124 and receives IGP routes from GRIB 124 only for nexthop resolution. In particular, second circuit board 102B does not need to perform route download or redistribution to BRIB 116, and therefore IPC traffic to the global RIB is several orders of magnitude less than in a conventional route reflection node.

Furthermore, circuit board 102B does not need to delay performing route advertisement to wait for forwarding information base (FIB) download operations to complete, as on a conventional router. Because route reflection servers do not often build or add routes into the FIB of the host router, the architecture herein does not impact the forwarding of packets by the first circuit board 102A.

Further processing capacity may be achieved by establishing one or more other instances of distributed BGP route reflection servers by separating address families and sub-address families. FIG. 3 is a block diagram of a packet router of FIG. 2 illustrating an example distributed and divided route information base (RIB) architecture. In FIG. 3, each graphical block represents a particular functional element in a process memory space that is separate from process memory used for all other functional elements. Thus, in the architecture of FIG. 3, a separate central processing unit may host and execute each different functional element that is illustrated, although the use of one processor per functional element is not required, and a single processor can host one or more of the functional elements.

A first packet data router 100A and a second packet data router 100B are communicatively coupled through a network 120. Each of the routers 100A, 100B comprises the elements of router 100 of FIG. 2. However, unlike FIG. 2 in which the global RIB 124 is hosted in a separate RRS 122, in FIG. 3 the router 100A hosts a GRIB 124A, which receives routes from a FIB 204A, OSPF process, and one or more static routes. GRIB 124A is responsible for inter-protocol comparison of routes received from any of a plurality of protocols including OSPF, IS/IS, etc.

The FIB 204A may form a part of forwarding plane logic 110 of a first circuit board. 102A (as seen in FIG. 2) in the router 100A. FIB 204A may be resident on a line card or coupled to a line card.

Router 100A further hosts a BRIB 116A that contains only routes for Internet Protocol version 4 (IPv4). BRIB 116A enables a BGP node to compare routes that have been learned from peers with one another (“intra-protocol comparison”); all of the best paths determined in such a comparison are then handled up to the global RIB 124A.

BRIB 116A is coupled to one or more BGP speakers 200A, 200B that can exchange IPv4 routes with peers and communicate with a BGP flow manager located elsewhere in the network. The use of separate BGP speaker processes enables separate route processors or other CPUs to host BGP speakers 200A, 200B and others, increasing scalability and providing fault isolation.

BRIB 116A requests and receives only routes from GRIB 124A that are needed for nexthop resolution. For purposes of illustrating a clear example, FIG. 2 shows one BRIB 116A in router 100A. However, an embodiment may include one BRIB per address family and per sub-address family. Each such BRIB functions as a separate software process in separate process memory space. Thus, router 100A may host a BRIB for IPv4, IPv6, VPNv4, VPNv6. As another example, router 100B hosts a second BRIB 116B that holds prefixes only for VPNv4 and is coupled to one or more other BGP speakers 200C, 200D.

Further, in certain embodiments, circuit boards may be constructed containing processors and memory that are selected or tuned according to the performance needs of a particular service. Thus, for example, a circuit board hosting a BRIB for VPNv6 might have a different combination of processor(s) and memory in a different size as compared to another circuit board that is hosting a BRIB and processing power for a different BGP service. A smaller service may have a smaller CPU and less memory; in contrast, if high availability is desired, multiple processors could be used with multiple memory banks for redundant operation of a particular service.

Each of the BGP speakers 200A, 200B can be isolated to update only one of the BRIBs. Further, BRIB 116A and BGP speakers 200A, 200B are hosted in entirely separate process spaces from one another. Thus, one BGP speaker and one BRIB for a particular AF or SAF may be associated with one processor, further enhancing scalability and fault isolation, without any impact on physical or logical connectivity.

Each such processor-speaker-BRIB combination may establish an independent peering session with another peer and may have a separate IP address for that purpose. Each such processor-speaker-BRIB may negotiate which services will be passed over a peering session using BGP dynamic capability negotiation techniques. Using dynamic capability negotiation, peers may negotiate an independent IP address per service. Alternatively or additionally, peers may migrate an existing peering session to a speaker process to facilitate use of multi-session BGP.

To illustrate a clear example, FIG. 3 shows a system in which prefixes are distributed among route reflection nodes based on particular protocols, e.g., IPv4 and VPNv4. In an alternate embodiment, the distribution boundary can be within AF/SAF boundaries for other services. For example, a particular distributed route reflection node as shown in FIG. 2 may host a BRIB that holds prefixes only for a particular address family, but for IPv4, VPNv4, and other services. Further, a BRIB in a distributed route reflection node as shown in FIG. 2 may host prefixes only for a particular sub-address family, but for any service.

In still another embodiment, a BGP route reflection server node as shown in FIG. 2 or FIG. 3 may use internally distributed processes. For example, the process distribution techniques described in prior co-pending application Ser. No. 10/677,797, filed Oct. 2, 2003, may be used. In all such embodiments, benefits accrue from separating route reflection logic and software elements from forwarding plane elements of a router, according to the techniques described herein.

Hardware elements of the circuit boards 102A, 102B may vary according to the traffic capacity anticipated for the apparatus. In one embodiment, each processor is an Intel or Sun 64-bit CPU running the Linux or Solaris operating systems. In another embodiment, a packet router 100 comprises two or more Gigabit Ethernet network interface cards that provide redundant network connectivity.

Each circuit board 102A, 102B typically comprises a large main memory such as 4 GB of RAM. Preferably, each circuit board 102A, 102B is independent and the functions thereof run in separate memory spaces. In one embodiment, each circuit board 102A, 102B is hosted in a separate hardware chassis to promote fault isolation; however, separate chassis are not required.

Circuit boards 102A, 102B also each host a TCP/IP stack and a local packet memory for purposes of supporting TCP segments and BGP sessions to the circuit boards.

In one embodiment, route reflector logic 114 is implemented as one or more software applications that execute on the processor 104B of second circuit board 102B. Other logic may be structured as a core application with a Web-based user interface that provides functions for selecting and installing one or more application modules. Such applications may include a VPNv4 route reflector and route server with monitor; a multi-context IPv4 route reflector and route server; centralized advanced virtual servers for VPN customers; an intelligent stress tester for BGP and IGPs; a monitor for OSPF and ISIS; and other applications.

As an example, an application providing a VPNv4 route reflector and route server with monitor may have the following features and functions:
Support for BGP and support for 2547bis;
Support for Extended Community ORF and RT-Constrain drafts;
Support of withdraw per Route Target or RD not per NLRI;
Support for several million VPNv4 routes and thousands of sessions;
Support for multiple paths distribution;
Full session isolation or at least per RD resource isolation (e.g., one or more sessions that are feeding a box with a given route's RD should not impact the operation of any other sessions with different RDs);
Auto fault isolation and session notification/drop;
Extensive build in reporting and monitoring facilities including SNMP traps & syslog logging based on predefined templates;
Full BGP table recording/dump for later replay capability & offline analysis;
Live BGP table (routes and paths) monitoring per RD:NLRI, RT and per any other BGP attribute or community or extended community;
Piped live monitoring to local or remote file (tftp, ftp, url etc . . . );
Statistics history of number of routes/path per RD & RTs;
Next-hop unchanged for outbound EBGP peers;
MD5 support with dual MD5 rollover facility;
Message pacing to protect slow provider edge device CPUs from being overloaded with many large BGP messages;
Auto detection for MSS;
Support for single sided provisioning and/or IBGP Auto Mesh a plus;
Support for easy migration from existing VPNv4 route reflectors by one way configuration translation;
Support for easy peer configuration grouping and dynamic allocation for identical group members;
Support for easy policing in 2547 Inter-AS option B (when peering to ASBRs) as well as support for Inter-AS option C (vpnv4 route broker service);
Full per PE VPN route statistics based on rtr_id of the received vpnv4 routes;
Extensive route flapping statistics & intelligent route dampening templates;
External VPN customer secure access into their routes via https
Support for BGP anomalies, such as multiple identical updates, excessive BGP withdraws, etc.

A BGP route reflection server approach has been described in which complete BGP route reflection server capability may be provided in an existing router device through the addition of a circuit board having specified components optimized for performing BGP route reflection services. In this approach, the router device is seen in the network as a single node even though it is providing BGP route reflection services in addition to packet forwarding. Only a single node requires OSPF/IS-IS links in the network, rather than having links between a route reflection server and a router as well as fully meshed links from the router node and all other nodes. Convergence time is improved because the circuit board may be configured with any required processor power. Separate management of a BGP RRS node is not required.

4.0 Extensions and Alternatives

In the foregoing specification, the invention has been described with reference to specific embodiments thereof. Generally, embodiments introduce specific route reflection logic and software elements to a distributed location in a router, such as an auxiliary circuit board within a functioning router. This approach allows additional scaling of services without impacting the high availability of the routing system or network convergence times.

Embodiments host one or more instances of separate BRIB and BGP speaker processes in entirely independent process memory spaces, unlike past approaches in which these elements are combined in a single process memory space for the purpose of optimizing operation with a single CPU. All such past approaches with a unified model cannot provide the benefits of scalability and fault isolation that are provided in the present approach. For example, past approaches with a unified model are constrained by the limits of one memory space that must hold both the BRIB and BGP speaker functional elements and that must handle all BGP services as a union. Further, such a unified model provides no fault isolation; failure of an IPv6 service, for example, will affect VPNv4 and all other services. The present approach overcomes these disadvantages.

In one embodiment, the approach herein can scale route reflection servers for L3VPN, VPLS, or any other protocol that is distributed in BGP and that does not affect route forwarding. The distributed software allows plug-and-play scaling of BGP services. The potential addition of a control board allows increased scaling, performance and availability attributes of the system.

The present approach also obviates certain enhancements that have been made to the BGP protocol and proposed in recent Internet-drafts and other documents. For example, a “soft notification” mechanism has been proposed in which a failure notification for only one failed service is sent even when multiple services are run over the same peering session. “Soft notification” is intended to prevent a failure of one service from affecting other services. However, the present approach provides complete service separation, so any notification that a particular service is down necessarily cannot affect any other service.

It will, however, be evident that various modifications and changes may be made thereto without departing from the broader spirit and scope of the invention. The specification and drawings are, accordingly, to be regarded in an illustrative rather than a restrictive sense.

What is claimed is:

1. A packet data router, comprising:
one or more first circuit boards comprising one or more first processors and first logic circuits programmed to perform packet data forwarding and packet data router control plane functions;
one or more second circuit boards comprising one or more second processors and second logic circuits programmed to perform only Border Gateway Protocol (BGP) route reflection server (RRS) functions.

2. A router as recited in claim 1, wherein the BGP RRS functions comprise a BGP peer state machine function, a BGP route information base (RIB) function, and a host I/O stack function.

3. A router as recited in claim 1, wherein the BGP RRS functions exclude a BGP global RIB function.

4. A router as recited in claim 1, wherein the BGP RRS functions comprise communicating using an inter-processor communication service to contact a separate global RIB to perform next hop resolution.

5. A router as recited in claim 1, wherein the router comprises a plurality of the second circuit boards, wherein each of the second circuit boards hosts an instance of BGP RRS functions.

6. A router as recited in claim 5, wherein each independent instance processes BGP information only for a particular address family and for all sub-address families that are associated with the particular address family.

7. A router as recited in claim 5, wherein each independent instance processes BGP information only for a particular service among a plurality of services that use BGP, and for all AFIs and SAFIs that use the particular service.

8. A router as recited in claim 1, wherein the first circuit boards each comprise a switching system, forwarding plane logic, and control plane logic, and wherein the second circuit boards do not comprise a switching system, forwarding plane logic, or control plane logic.

9. A packet data routing apparatus, comprising:
first circuit means comprising one or more first processors and first logic circuits for performing packet data forwarding and packet data router control plane functions;
second circuit means comprising one or more second processors and second logic circuits for performing only Border Gateway Protocol (BGP) route reflection services (RRS).

10. Apparatus as recited in claim 9, wherein the BGP RRS means comprise means for performing BGP peer state machine functions, means for managing a BGP route information base (RIB), and means for performing a host I/O stack function.

11. Apparatus as recited in claim 9, wherein the BGP RRS functions exclude a BGP global RIB function.

12. Apparatus as recited in claim 9, wherein the BGP RRS functions comprise communicating using an inter-processor communication service to contact a separate global RIB to perform next hop resolution.

13. Apparatus as recited in claim 9, wherein the router comprises a plurality of the second circuit means, wherein each of the second circuit means hosts an instance of BGP RRS functions.

14. Apparatus as recited in claim 13, wherein each independent instance processes BGP information only for a particular address family and for all sub-address families that are associated with the particular address family.

15. Apparatus as recited in claim 13, wherein each independent instance processes BGP information only for a particular service among a plurality of services that use BGP, and for all AFIs and SAFIs that use the particular service.
